(19) United States
(12) Patent Application Publication
(10) Pub. No.: US 2008/0160392 A1
(43) Pub. Date: Jul. 3, 2008

(54) Cylindrical battery

(76) Inventors: Shoichi Toya, Minamiawaji-shi (JP); Taishi Maeda, Takasaki-shi (JP); Hidefumi Isaji, Takasaki-shi (JP); Yasunori Fujimori, Tano-gun (JP)

Correspondence Address: WENDEROTH, LIND & PONACK, L.L.P., 2033 K STREET N. W., SUITE 800, WASHINGTON, DC, 20006-1021, US

(21) Appl. No.: 12/005,339

(22) Filed: Dec. 27, 2007

(30) Foreign Application Priority Data
Dec. 29, 2006 (JP) 2006-356923
Sep. 14, 2007 (JP) 2007-239120

(51) Int. Cl. H01M 10/48; H01M 2/02

(52) U.S. Cl. 429/90; 429/174

(57) ABSTRACT

The board assembly portion includes a circuit board, a communication terminal, and an insulating formed section. A data-processing circuit is mounted on the circuit board. The insulating formed section positions the communication terminal in a predetermined position. A penetrating opening is formed in the central part of the board assembly portion to receive the protruding terminal of the base battery portion. The communication terminal that is formed in a ring shape is secured around the periphery of the penetrating opening on the upper surface side of the board assembly portion. The protruding terminal of the base battery portion has a height that protrudes from the upper surface of the board assembly portion. In the state where the board assembly portion is secured to the base battery portion, the whole cylindrical battery has the same exterior size as a standard size battery.

### BACKGROUND OF THE INVENTION

1. Field of the Invention

The present invention relates to a cylindrical battery that has the same exterior shape as a standard size battery, and in particular a cylindrical battery that includes a data-processing circuit. Also, the present invention relates to a cylindrical battery that has a small exterior battery shape but includes a circuit board.

2. Description of the Related Art

Battery packs have been developed that include an electronic circuit (see Japanese Patent Laid-Open Publication H9-63552, Domestic Announcement 2003-516604, and Japanese Patent Laid-Open Publication 2004-265722).

The battery packs provides various types of functions by means of the electronic circuit, and can be conveniently used. In the battery pack disclosed in Japanese Patent Laid-Open Publication H9-63552, the electronic circuit is used as a protection circuit that protects a battery in charging/discharging operation. The battery pack controls charging/discharging operation of the battery by means of the protection circuit, and as a result can use the battery so that the battery is protected. Also, in the battery pack, the cylindrical battery is accommodated in an exterior case that is formed of sheet metal. In the exterior case, a circuit board is arranged in an opening, and the terminals that are fastened to the circuit board are exposed externally from the opening of the exterior case. The circuit board is connected to the positive and negative terminals of the cylindrical battery that is accommodated in the exterior case.

Also, in Domestic Announcement 2003-516604, an electronic circuit housing is described that is mounted to a battery. This document describes that the electronic circuit that is mounted in the housing detects the charging/discharging operation cycles of the battery, insulates the battery, and detects overheating, inverse polarity, short-circuit, over-pressure, over-charge, over-discharge or remaining battery life. Accordingly, the battery pack that is provided with the electronic circuit transmits information such as remaining battery life to a device that uses the battery pack as a power supply.

Also, Japanese Patent Laid-Open Publication 2004-265722 discloses a structure that provides signal of a protection element and is accommodated in an AA size battery exterior shape.

### SUMMARY OF THE INVENTION

In the battery pack disclosed in Japanese Patent Laid-Open Publication H9-63552, since the cylindrical battery is accommodated in the exterior case of a metal casing, and additionally the circuit board is mounted that includes the positive and negative terminals that are arranged in the opening of the exterior case, the exterior size of the battery pack will be larger than an AA size battery or the like that is accommodated in the exterior case. Accordingly, in the case where the circuit board is mounted to the battery pack, this battery pack cannot be used as a substitute for an AA size battery. This battery pack requires a specially-designed battery holder. In the case of an electric device that has the specially-designed battery holder, if this battery pack cannot be used, commercial AA size batteries cannot be used as a substitute for this battery pack. For this reason, users always use the specially-designed battery pack. Therefore, the users always necessarily keep in mind the remaining capacity of the battery pack. In addition to this, the structure of the battery pack is complicated as a whole, and as a result the manufacturing cost of the battery pack will be high. The reason is that a double metal casing structure is required that includes an exterior can of an AA size battery and an exterior case that accommodates the AA size battery, that an opening of the exterior case as a metal casing is closed by a plastic lid of an insulating material, that positive and negative terminals are fastened to this plastic lid, that the positive and negative terminals are connected to the circuit board, that the circuit board is arranged inside the plastic lid, and that the circuit board is connected to the battery.

Also, since the electronic circuit housing disclosed in Domestic Announcement 2003-516604 is mounted to a battery such as an AA size battery in use, the exterior size of the battery that is provided with the electronic circuit housing is larger than the standard size of AA size battery, for example. Accordingly, in the case of the battery device that is composed of the battery and the electronic circuit housing, similar to the case of the battery pack disclosed in Japanese Patent Laid-Open Publication H9-63552, the battery device cannot be used as a substitute for an AA size battery. This battery device requires a specially-designed battery holder. Also, in the case of the battery device, since a standard size battery such as an AA size battery is used in combination with the electronic circuit housing that is coupled to the standard size battery, the structure of the battery device is complicated as a whole. In addition to this, it is difficult that the electronic circuit housing is stably secured to the battery device. In particular, since the positive terminal as an output terminal is fastened to the housing, the positive terminal is fastened to the standard size battery through the housing. In this structure, in order to stably secure the positive terminal in a tight manner, it is necessary to firmly secure the positive terminal to the housing, and additionally to firmly secure the housing to the standard size battery. Also, time and effort are required to stably and exactly secure the positive terminal in place. Also, since the positive terminal is coupled to the standard size battery through the housing, in order to prevent positioning deviation of the positive terminal, it is necessary to exactly secure the housing at a predetermined position of the standard size battery. For this reason, high accuracy is required for securing the positive terminal the housing. In addition to this, high accuracy is required for a part that couples the housing to the standard size battery. It is because the positioning deviation of the positive terminal causes poor contact when the battery device is mounted to an electric device. If the structure of the housing is complicated, and high processing accuracy is required, the manufacturing cost of the housing that includes the electronic circuit becomes high. As a result, it is difficult to inexpensively mass-produce the housing.

The present invention has been developed for solving the disadvantages. It is an important object of the present invention to provide a cylindrical battery that can be used as a substitute for a standard size battery. It is another important object of the present invention to provide a cylindrical battery that has a simple arrangement but can be arranged so that the positive terminal of the cylindrical battery is exactly positioned at a predetermined position without positioning deviation, and a circuit board is positioned at a predetermined position by the positive terminal of the cylindrical battery.

To achieve the foregoing objects, a cylindrical battery according to the present invention has the following configuration.

The cylindrical battery includes a base battery portion, and a board assembly portion that is secured on an end of the base battery portion on a protruding terminal side. The base battery portion includes an exterior case 11 that has a sealing structure that accommodates electrodes and electrolysis solution. The exterior case includes a cylindrical exterior can and a sealing plate that closes and seals an opening of the exterior can by caulking. The sealing plate is provided with a caulked protruding section by caulking on the outer peripheral rim of the sealing plate. The sealing plate is provided with the protruding terminal in the central part of the sealing plate. The protruding terminal serves as the positive terminal of the base battery portion. The exterior can serves as the negative terminal of the base battery portion. The board assembly portion includes a circuit board that is provided with a data-processing circuit, a communication terminal that is connected to the data-processing circuit on the circuit board, and an insulating formed section that insulates the circuit board and positions the communication terminal at a predetermined position. A penetrating opening is formed in the central part of the board assembly portion to receive the protruding terminal of the base battery portion. The communication terminal that is formed in a ring shape is secured around the periphery of the penetrating opening on the upper surface side of the board assembly portion. A connection metal plate is secured on the surface of the sealing plate, and includes a connection tab that is connected to the circuit board. In the cylindrical battery, the protruding terminal of the base battery portion is inserted into the penetrating opening of the board assembly portion so that the board assembly portion is secured on the end of the base battery portion on the protruding terminal side. The connection tab of the connection metal plate is connected to the circuit board so that the circuit board is connected to the protruding terminal. In addition to this, in the cylindrical battery, the protruding terminal of the base battery portion has a height that protrudes from the upper surface of the board assembly portion that is secured to the base battery portion. The whole cylindrical battery has the same exterior size as a standard size battery in the state where the board assembly portion is secured to the base battery portion.

Since the aforementioned cylindrical battery has the same exterior size as a standard size battery, the cylindrical battery has a feature in that the cylindrical battery can be used as a substitute for a standard size battery, which is mounted to a battery holder of an electric device. In addition to this, since the circuit board and the communication terminal are simply arranged around the periphery of the protruding terminal that correspond to a protruding terminal that is arranged in a sealing plate of a standard size battery, and the protruding terminal that is secured to the sealing plate protrudes outward and serves as the positive terminal of the cylindrical battery, the cylindrical battery has features in that the positive terminal of the cylindrical battery can be exactly positioned at a predetermined position without positioning deviation, and the circuit board can be positioned at a predetermined position by the protruding terminal. The features are provided by the unique structure of the cylindrical battery. That is, the circuit board that is provided with the data-processing circuit is arranged around the periphery of the protruding terminal, and the penetrating opening is formed in the central part of the circuit board. The protruding terminal is inserted into the penetrating opening. In addition to this, the communication terminal that is composed of a ring-shaped sheet metal is arranged to overlap the circuit board in an insulated state. The communication terminal is arranged outside the protruding terminal and inside the caulked protruding section in a position lower than the top surface of the protruding terminal in an orientation parallel to the sealing plate so that the communication terminal is insulated from the protruding terminal and the exterior can.

In addition to this, in the cylindrical battery, since the connection metal plate that is provided with the connection tab is secured on the surface of the sealing plate, and the connection tab of the connection metal plate is connected to the circuit board so that the protruding terminal is connected to the circuit board, the sealing plate as the positive terminal can be easily, surely and electrically connected to the circuit board.

Also, in the case where the cylindrical battery according to the present invention has the same exterior size as an AA size battery, the cylindrical battery can be conveniently used for a battery holder of an electric device as a substitute for an AA size battery, which is adaptable to a wide variety of applications.

Also, in the cylindrical battery according to the present invention, in the case where the data-processing circuit that is provided on the circuit board is connected to the positive and negative terminals of the base battery portion to be supplied with electric power from the base battery portion, even if the battery is not mounted to an external electronic device, the data-processing circuit can be operated to control the state of the battery.

Also, in the cylindrical battery according to the present invention, in the case where the insulating formed section includes a first insulating formed part that is arranged between the circuit board and the communication terminal, and a second insulating formed part that is coupled to the first insulating formed part and covers the outer peripheries of the circuit board and the communication terminal, the first insulating formed part that is arranged between the circuit board and the communication terminal can insulate the circuit board and the communication terminal from each other and allows the circuit board and the communication terminal to be arranged in predetermined positions, and additionally the second insulating formed part can insulate the outer peripheries of the circuit board and the communication terminal from each other.

Also, in the cylindrical battery according to the present invention, in the case where the first insulating formed part has a ring-shaped stepped area that can receive the communication terminal, and the communication terminal is fitted in the stepped area, the first insulating formed part can insulate the communication terminal from the circuit board and allows the communication terminal to be arranged in a predetermined position.

Also, in the cylindrical battery according to the present invention, a ring-shaped groove can be arranged between the protruding terminal and the caulked protruding section, and additionally the first insulating formed part can include support legs that are inserted into positioning openings that are formed in the circuit board so that, when the support legs pass through the circuit board and are arranged in the ring-shaped groove, the first insulating formed part is secured at a predetermined position of the base battery portion.

In this cylindrical battery, since the ring-shaped groove is arranged between the protruding terminal and the caulked protruding section, and the insulating ring is arranged in the ring-shaped groove, the insulating ring can be arranged in a predetermined position of an AA size battery without positioning deviation to insulate the circuit board.

Also, in the cylindrical battery according to the present invention, in the case the circuit board has notches on the outer peripheral rim of the circuit board, and is connected to the positive and negative terminals of the base battery portion in the notches, the cylindrical battery has a feature in that the circuit board can be arranged in a predetermined position of the sealing plate, and the circuit board and an AA size battery are easily and electrically connected to each other.

Also, in the cylindrical battery according to the present invention, the connection metal plate that is provided on its outer periphery with the connection tab that is connected to the circuit board can be secured on the surface of the sealing plate, and additionally the connection tab of the connection metal plate can be connected to the circuit board in the notch of the circuit board so that the circuit board is connected to the protruding terminal. In this case, the sealing plate as the positive terminal can be easily, surely and electrically connected to the circuit board.

Also, in the cylindrical battery according to the present invention, in the case where the data-processing circuit that is provided on the circuit board calculates one type of or a plurality types of information on the remaining capacity of the battery, the deterioration degree of the battery, and the memory effect of the battery, and provides the one type of or the plurality types of information through the communication terminal, the cylindrical battery can be conveniently used.

Furthermore, a cylindrical battery according to the present invention includes a base battery portion, and a board assembly portion that is secured on an end of the base battery portion on a protruding terminal side. The base battery portion includes a cylindrical exterior case and a sealing plate to form a sealing structure that accommodates electrodes and electrolysis solution. The exterior case includes a cylindrical exterior can and a sealing plate that closes an opening of the exterior can by caulking. The sealing plate is provided with the protruding terminal in the central part of the sealing plate. The protruding terminal serves as the positive terminal of the base battery portion. The exterior can serves as the negative terminal of the base battery portion. In addition to this, the board assembly portion includes a circuit board that is provided with an electronic element, and an insulating formed section that insulates the circuit board. A connection metal plate is secured on the surface of the sealing plate, and includes a connection tab that is connected to the circuit board. In the cylindrical battery, the board assembly portion is secured on the end of the base battery portion on the protruding terminal side, and the connection tab of the connection metal plate is connected to the circuit board so that the circuit board is connected to the protruding terminal. In addition to this, in the cylindrical battery, the protruding terminal of the base battery portion has a height that protrudes from the upper surface of the board assembly portion that is secured to the base battery portion, and the whole cylindrical battery has the same exterior size as a standard size battery.

In the aforementioned cylindrical battery, since the board assembly portion is secured to an end of the base battery portion on the protruding terminal side, and the protruding terminal of the base battery portion has a height that protrudes from the upper surface of the board assembly portion that is secured to the protruding terminal, there is a feature in that a multifunction cylindrical battery can be provided by the electronic device that is mounted on the board assembly portion that is arranged at the end on the protruding terminal side. In particular, in the cylindrical battery, since, in the state where the protruding terminal protrudes from the upper surface of the board assembly portion, the board assembly portion is secured to the end of the base battery portion on the protruding terminal side, space around the protruding terminal can be effectively used so that the board assembly portion is arranged in an ideal arrangement, and the cylindrical battery can be conveniently used by functions of the electronic device that is mounted on the board assembly portion.

Also, since the base battery portion itself can have a sealing structure of a base battery portion that is used as the conventional technology except that the protruding terminal protrudes, the base battery portion itself can have a simple structure and can be easily manufactured. In addition to this, the base battery portion itself can have high reliability of electrolysis solution leak prevention and measures of safety valve against battery internal pressure rise.

In addition to this, since the connection metal plate that is provided with the connection tab is secured on the surface of the sealing plate, and the connection tab of the connection metal plate is connected to the circuit board so that the protruding terminal is connected to the circuit board, the sealing plate as the positive terminal can be easily, surely and electrically connected to the circuit board.

Also, in the cylindrical battery according to the present invention, the exterior case can be provided with a caulked protruding section on the outer peripheral rim of the sealing plate by the caulking, and the negative terminal that is connected to the circuit board can be connected to the caulked protruding section. In this case, the exterior can as the negative terminal can be easily, surely and electrically connected to the circuit board.

Also, in the cylindrical battery according to the present invention, in the case where the circuit board of the board assembly portion is provided with a data-processing circuit that calculates the remaining capacity of the battery, the cylindrical battery can display the remaining capacity of the battery, and additionally has the same exterior size as a standard size battery as a whole so that the cylindrical battery can be used similarly to the standard size battery.

Also, in the cylindrical battery according to the present invention, in the case where a data-processing circuit that is provided on the circuit board to calculate a battery remaining capacity is operated by electric power that is supplied from the base battery portion, and the data-processing circuit calculates the battery remaining capacity of the base battery portion that is used as a power supply that operates the data-processing circuit, the cylindrical battery has features in that the structure of the cylindrical battery can be simple but the remaining capacity of the battery can be displayed.

Also, in the cylindrical battery according to the present invention, in the case where the board assembly portion includes a display section that displays a battery remaining capacity, and a switch that causes the display section to display the battery remaining capacity, when the switch is operated if needed, the remaining capacity of the battery can be displayed.

The above and further objects of the present invention as well as the features thereof will become more apparent from the following detailed description to be made in conjunction with the accompanying drawings.

### BRIEF DESCRIPTION OF THE DRAWINGS

FIG. 1 is a perspective view showing a cylindrical battery on a protruding terminal side according to one embodiment of the present invention;

FIG. 2 is an exploded perspective view of the cylindrical battery shown in FIG. 1;

FIG. 3 is an exploded perspective view of the cylindrical battery shown in FIG. 2;

FIG. 4 is a perspective sectional view of the cylindrical battery shown in FIG. 1;

FIG. 5 is a perspective view showing the cylindrical battery on the protruding terminal side;

FIG. 6 is a perspective view showing the back surface of a circuit board;

FIG. 7 is a perspective view showing a communication terminal;

FIG. 8 is a perspective view showing a first insulating formed part;

FIG. 9 is a perspective view showing the back surface of the first insulating formed part shown in FIG. 8;

FIG. 10 is a perspective view showing a second insulating formed part;

FIG. 11 is a perspective view showing the back surface of the second insulating formed part shown in FIG. 10;

FIG. 12 is a perspective view showing a cylindrical battery on a protruding terminal side according to another embodiment of the present invention;

FIG. 13 is an exploded perspective view of the cylindrical battery shown in FIG. 12;

FIG. 14 is an exploded perspective view of the cylindrical battery shown in FIG. 13;

FIG. 15 is a perspective sectional view of the cylindrical battery shown in FIG. 12;

FIG. 16 is a perspective view showing a circuit board; and

FIG. 17 is a perspective view showing an insulating formed section.

### DETAILED DESCRIPTION OF THE PREFERRED EMBODIMENT(S)

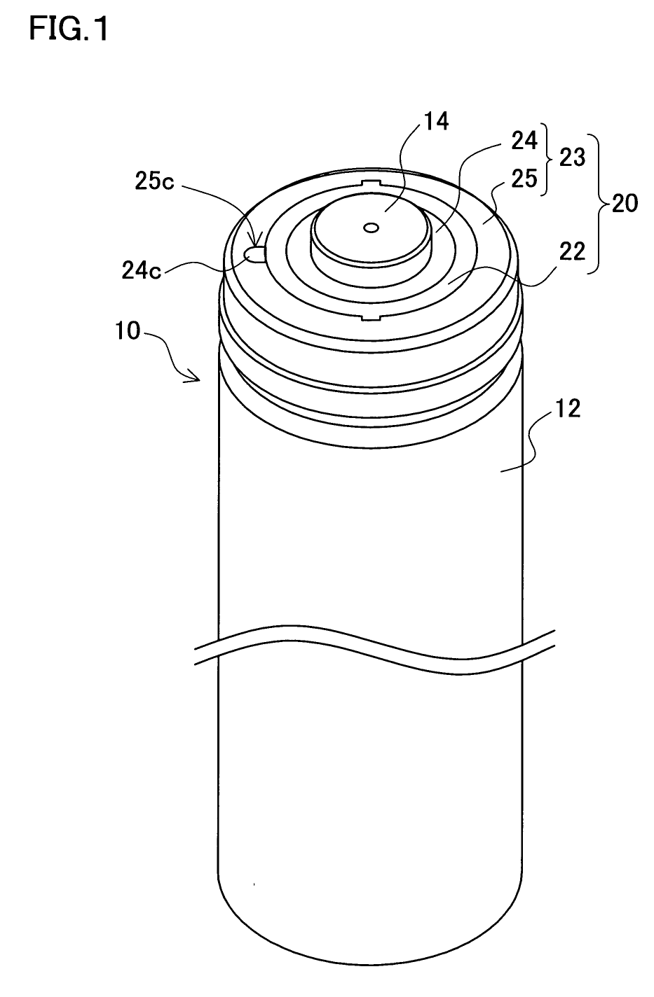

A cylindrical battery shown in FIGS. 1 through 4 is a cylindrical AA size battery that has the same exterior size as an AA standard size battery. The following description describes the cylindrical battery as a cylindrical AA size battery according to an embodiment of the present invention. However, the cylindrical battery (a pipe or tube type battery) according to the present invention is not limited to an AA size battery. The cylindrical battery according to the present invention has a standard size exterior shape. The exterior shape of a cylindrical battery according to the present invention can be a circular cylindrical D, C or AAA size battery, or a prismatic battery, for example, a PP3 size battery.

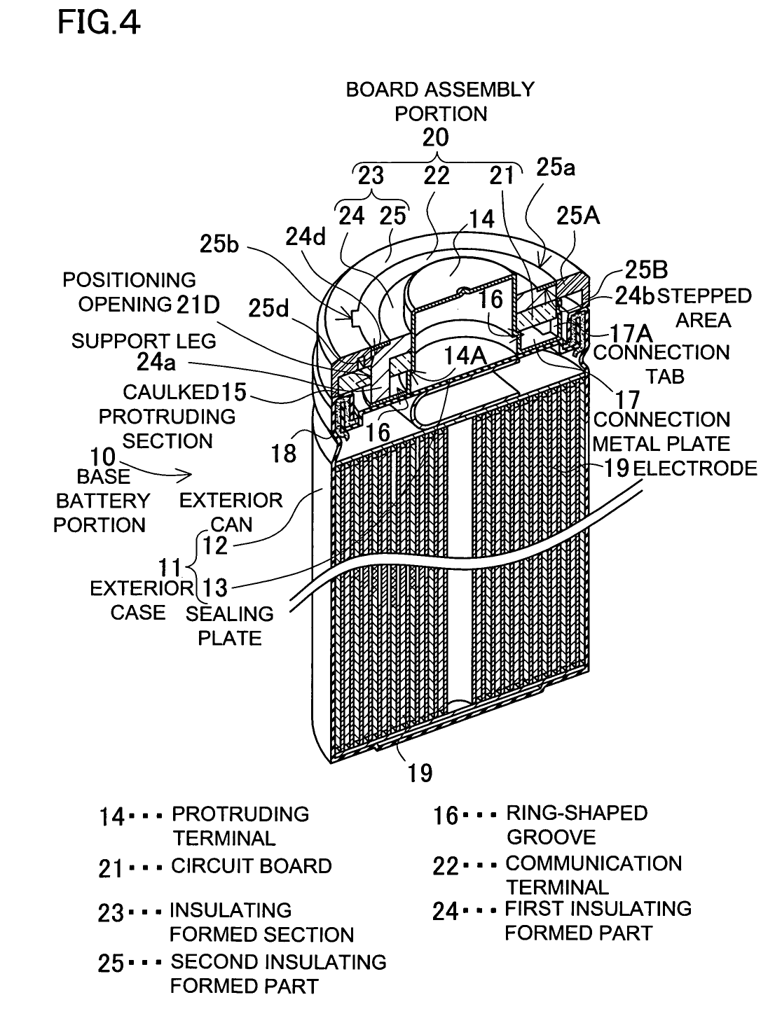

The cylindrical battery shown in FIGS. 1 through 4 includes a base battery portion 10, and a board assembly portion 20 that is secured on an end of the base battery portion 10 on a protruding terminal 14 side. As shown in FIGS. 4 and 5, the base battery portion 10 includes an exterior case 11 that has a sealing structure that accommodates electrodes 19 and electrolysis solution. The exterior case 11 includes an exterior can 12 that is formed from a sheet metal into a circular cylindrical shape by presswork, and a sealing plate 13 that is formed of a sheet metal that closes the opening of the exterior can 12. The sealing plate 13 is fastened to the exterior can 12 by caulking the outer peripheral rim of the sealing plate 13 so that the opening of the exterior can 12 is sealed by the sealing plate 13. The sealing plate 13 is provided on the outer peripheral rim of the sealing plate 13 with a caulked protruding section 15 by caulking. The sealing plate 13 and the exterior can 12 are caulked to interpose an insulating member 18, and, in a well-known manner, the sealing plate 13 is connected to the electrode of the positive terminal, and the exterior can 12 is connected to the electrode of the negative terminal. The sealing plate 13 is provided with the protruding terminal 14 in the central part of the sealing plate 13. A ring-shaped groove 16 is formed between the protruding terminal 14 and the caulked protruding section 15.

In the cylindrical battery according to the present invention, in the state where the board assembly portion 20 is secured to the base battery portion 10 on the protruding terminal 14 side, the cylindrical battery has the same exterior size as a standard size battery. Accordingly, as compared with a typical standard size battery, which does not include the board assembly portion 20, the size of the base battery portion 10 is reduced corresponding to the size of the board assembly portion 20. Since the board assembly portion 20 is secured to the base battery portion 10 on the protruding terminal 14 side, the size of the base battery portion 10 is reduced corresponding to this part, that is, the length of the exterior can 12 is slightly shorter. Note that, in the cylindrical battery according to the present invention, since the protruding terminal 14 of the base battery portion 10 protrudes from the board assembly portion 20 to serve as the positive terminal of the output terminals, the dimension from the top end of the protruding terminal 14 to the bottom of the exterior can 12 is the same as the dimension of a general standard size battery, which does not include a board assembly portion. For this reason, the cylindrical battery according to the present invention, the height of the protruding terminal 14 of the base battery portion 10 that protrudes from the sealing plate 13 is configured higher than a general standard size battery.

In the illustrated cylindrical battery, in the state where the board assembly portion 20 is secured to the base battery portion 10, the cylindrical battery has the same exterior size as an AA size battery. In other words, the board assembly portion 20 is configured in an exterior shape that gives the cylindrical battery the same exterior shape as a standard AA size battery in the state where the board assembly portion 20 is secured to the base battery portion 10. The board assembly portion 20 includes a circuit board 21 that is provided with a data-processing circuit, a communication terminal 22 that transmits signals that are provided from the data-processing circuit to an external device, and an insulating formed section 23 that insulates the circuit board 21 and positions the communication terminal 22 at a predetermined position. In the illustrated board assembly portion 20, the insulating formed section 23 includes a first insulating formed part 24 and a second insulating formed part 25 that are separately formed. The first insulating formed part 24 is arranged between the circuit board 21 and the communication terminal 22. The second insulating formed part 25 is coupled to the first insulating formed part 24 and covers the outer peripheries of the circuit board 21 and the communication terminal 22.

In the illustrated cylindrical battery, in the state where the board assembly portion 20 is secured to the end of the base battery portion 10 on the protruding terminal 14 side, the protruding terminal 14 of the base battery portion 10 protrudes from the board assembly portion 20 to serve as an output terminal on the positive terminal side. For this reason, the board assembly portion 20 is provided on its central part with a penetrating opening 26 that receives the protruding terminal 14 of the base battery portion 10. When the protruding terminal 14 is inserted into the penetrating opening 26, the board assembly portion 20 is arranged at a predetermined position of the end of the base battery portion 10.

However, in the present invention, the shape of the board assembly portion is not limited to a ring shape that has a penetrating opening into which the protruding terminal of the base battery portion is inserted. Although not illustrated, the board assembly portion can have various types of shapes that allow the board assembly portion to be arranged on the end surface of the base battery portion on the protruding terminal side. In the cylindrical battery, for example, in the case where a circular cylindrical battery is used as the base battery portion, the shape of the board assembly portion can be a C shape or a sector shape that extends along the outer periphery of the cylindrical battery. Also, in the case where a prismatic battery is used as the base battery portion, the shape of the board assembly portion can be a rectangular parallelepiped shape that has an outer periphery that extends along the outer periphery of the prismatic battery. The board assembly portion does not necessarily extend along the whole periphery of the protruding terminal, but can be arranged to extend along a part of the periphery of the protruding terminal.

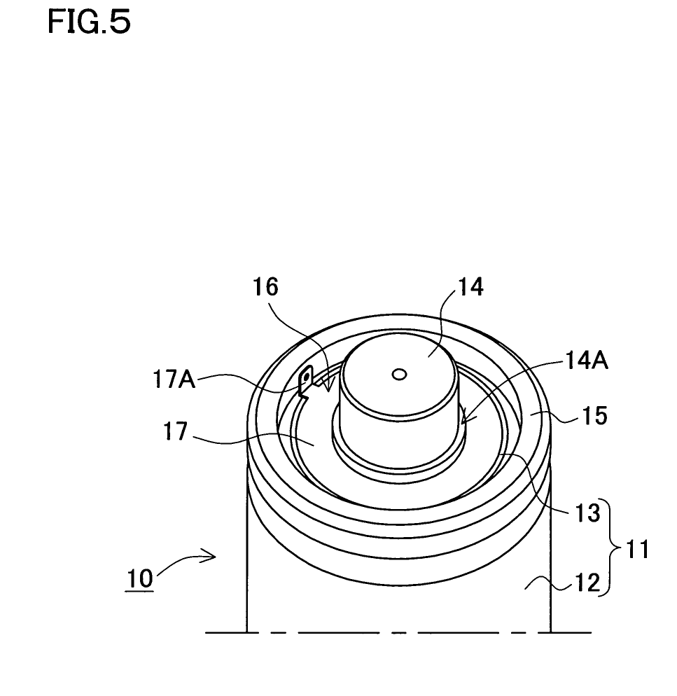

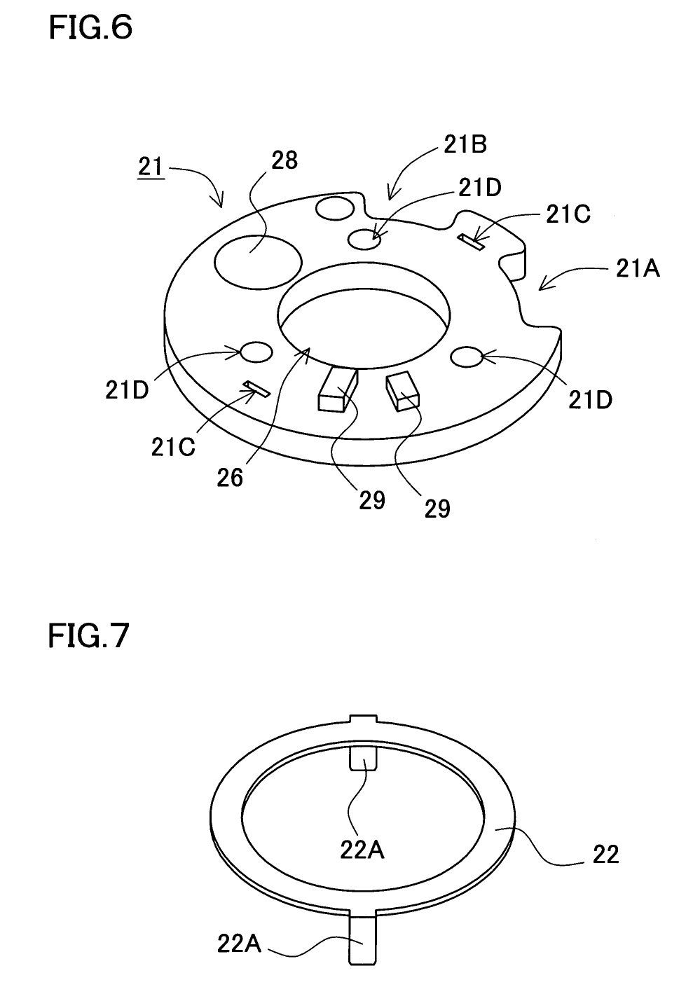

Also, in the board assembly portion 20, the circular, ring-shaped communication terminal 22 is secured around the periphery of the penetrating opening 26 on the upper surface side of the board assembly portion 20. In the board assembly portion 20, the first insulating formed part 24 is arranged on the surface of the circuit board 21, and the communication terminal 22 is secured on the first insulating formed part 24. The penetrating opening 26 that penetrates the board assembly portion 20 penetrates the circuit board 21, the insulating formed section 23, and the communication terminal 22. The circuit board 21 shown in FIG. 6 has a circular outline shape as a whole in plan view. The penetrating opening 26 of the board assembly portion 20 is formed in the center of the board assembly portion 20. Also, the illustrated circuit board 21 is provided with COB (CHIP ON BOARD) type ASIC (Application Specific Integrated Circuit) 28, and an external part 29 that compose the data-processing circuit. The data-processing circuit calculates the remaining capacity of the battery and the deterioration degree of the battery, and detects the memory effect of the battery, and provides the calculation result and detection result through the communication terminal 22 to the device that is equipped with the cylindrical battery.

The data-processing circuit that calculates the remaining capacity of the battery integrates currents in charging/discharging operation of the battery to calculate the remaining capacity. That is, the data-processing circuit that calculates the remaining capacity integrates charging currents and adds the integrated charging current value to a remaining capacity value, and integrates discharge currents and subtracts the integrated discharging current value from the remaining capacity value. The charging/discharging currents of the battery that are used for the calculation of remaining capacity are detected by the electric device (not shown) that is quipped with the battery. The detected charging/discharging currents are transmitted to the data-processing circuit from the communication terminal 22. Alternatively, a current detector circuit is installed in the data-processing circuit, and the charging/discharging currents are detected.

The data-processing circuit that detects the deterioration degree of the battery detects the charging/discharging operation cycles of the battery, and calculates the deterioration degree. Alternatively, the data-processing circuit calculates the deterioration degree based on the total capacity of the charging capacity and the discharging capacity of the battery. Since the battery deteriorates as the number of charging/discharging operation cycles increases, the deterioration degree can be detected by counting the number of charging/discharging operation cycles. Also, since the battery deteriorates as the charging/discharging amounts of the battery increases, the deterioration degree can be calculated based on the total capacity of the charging capacity and the discharging capacity of the battery.

In addition to this, the data-processing circuit that detects the memory effect of the battery detects the memory effect based on the charging/discharging operation state of the battery. In the case of a nickel-hydrogen battery or a nickel-cadmium battery, if the battery is repeatedly recharged after being only partially discharged, the actual charging/discharging amount of the battery decreases (memory effect). Accordingly, detection of partial charging/discharging operation can detect decrease of the actual charging/discharging amount of the battery caused by memory effect. When the memory effect makes the actual capacity of the battery small, the data-processing circuit provides the electric device through the communication terminal 22 with a signal that represents that memory effect occurs. If the electric device receives the signal that represents that memory effect occurs in the battery, the electric device causes the battery to be sufficiently discharged and then to be fully charged to eliminate the memory effect.

The aforementioned data-processing circuit detects the remaining capacity, and the deterioration degree, the memory effect of the battery, however, the cylindrical battery according to the present invention does not necessarily detect all of them. The cylindrical battery according to the present invention may detect one of or two of them, or may detect other property of the battery than the remaining capacity, the deterioration degree and the memory effect, e.g., the actual capacity depending on the temperature of the battery, and may provide the one of or two of them, or the other property to the electric device.

The illustrated data-processing circuit of the circuit board 21 is operated by electric power that is supplied from the base battery portion 10. Accordingly, the circuit board 21 is connected to the positive and negative terminals of the base battery portion 10. The illustrated circuit board 21 is provided with notches 21A and 21B to be connected to the positive and negative terminals of the base battery portion 10. The illustrated circuit board 21 is provided the two notches 21A and 21B on the outer periphery of the circuit board 21. One notch 21A is provided for the positive terminal. Other notch 21B is provided for the negative terminal.

The illustrated circuit board 21 is connected to the positive terminal of the base battery portion 10 through the connection metal plate 17. The connection metal plate 17 is a sheet metal that has a connection tab 17A that is connected to the circuit board 21 and protrudes from the outer periphery of the connection metal plate 17. The connection metal plate 17 is secured on the upper surface of the sealing plate 13. In the base battery portion 10 shown in FIG. 4 and FIG. 5, the protruding terminal 14 is electrically connected to the connection metal plate 17 that is secured to the upper surface of the sealing plate 13 so that the connection metal plate 17 serves as a part of the protruding terminal. The illustrated protruding terminal 14 has a two stepped drawing structure. The lower outer diameter of the protruding terminal 14 is greater than the upper outer diameter of the protruding terminal 14. The protruding terminal 14 is provided in the lower part of the protruding terminal 14 with a stepped part 14A. The circuit board 21 is arranged on the stepped part 14A of the protruding terminal 14. The protruding terminal 14 supports the lower surface of the circuit board 21 so that the circuit board 21 can be arranged in a predetermined position. The inner diameter of the penetrating opening 26 of the circuit board 21 that is supported by the stepped part 14A is smaller than the outer diameter of the stepped part 14A, and is greater than the outer diameter of the upper part of the protruding terminal 14 above the stepped part 14A. The connection metal plate 17 is secured to the sealing plate 13 by spot welding. The connection tab 17A of the connection metal plate 17 is bent upward, and is arranged in the notch 21A of the circuit board 21. The connection tab 17A is connected to the circuit board 21 by soldering, spot welding, wire-bonding or the like. Note that, although the connection metal plate 17 has a ring shape, the connection metal plate may have other shape than a ring shape that can transmit electric power from the sealing plate 13 at low electrical power loss.

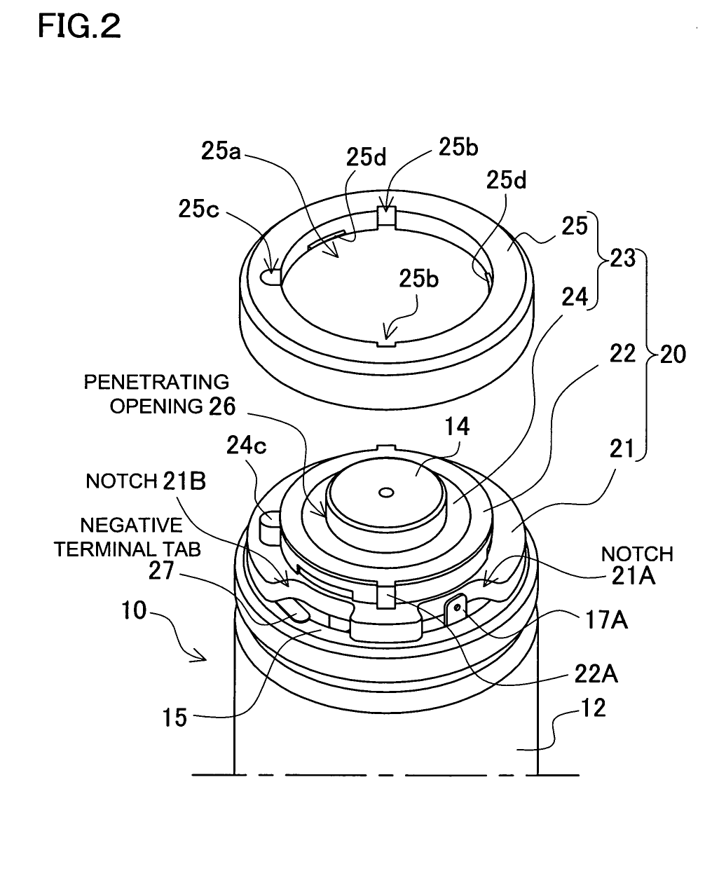

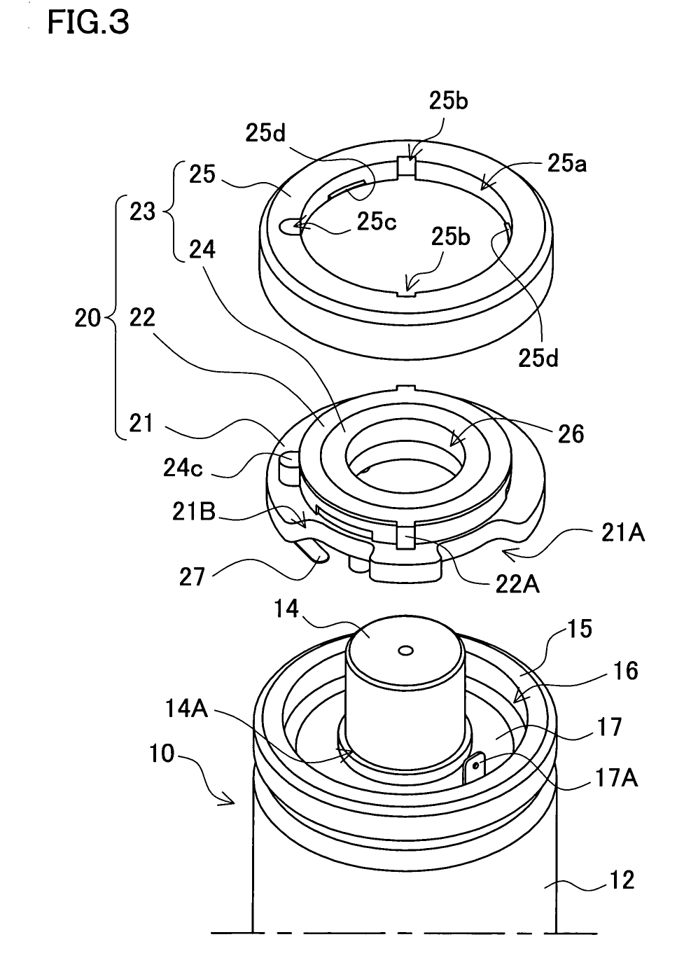

Also, the circuit board 21 is connected to the negative terminal of the base battery portion 10 through the negative terminal tab 27, as shown in FIG. 2 and FIG. 3. The negative terminal tab 27 of the circuit board 21 is secured and is connected to the exterior can 12 as the negative terminal of the base battery portion 10. The negative terminal tab 27 is a sheet metal, and is arranged in the notch 21B of the circuit board 21. The negative terminal tab 27 is connected to the circuit board 21 by soldering, spot welding, wire-bonding or the like. The negative terminal tab 27 that is arranged in the notch 21B is secured to the caulked protruding section 15 of the exterior can 12 by spot welding or the like.

The aforementioned circuit board 21 is supplied with electric power from the base battery portion 10, however, in the cylindrical battery according to the present invention, the circuit board is not necessarily supplied with electric power from the base battery portion. The circuit board may be supplied with electric power from the communication terminal. In this case, for example, in the cylindrical battery, the output side of the circuit board is connected to the negative terminal of the battery. The circuit board is not connected to the positive terminal of the battery but is connected to the communication terminal. In this case, in the state where the cylindrical battery is connected to the external electronic device (e.g., charger), the circuit board is supplied with electric power through the communication terminal that is connected to the output terminal of the external electronic device. In this case, in the state where the cylindrical battery is used as a power supply in a normal case, the circuit is not operated. The circuit is supplied with electric power and is operated only in the state where the cylindrical battery is connected to the external electronic device. The data-processing circuit can be a circuit that stores various types of information about the battery that are provided from the external electronic device, for example. The circuit stores the various types battery information such as the current battery capacity when the battery is fully charged, the current number of charge charging operation cycles, a refresh requirement signal that represents the need for discharging the battery to eliminate memory effect, a life determination signal that represents the life of the battery.

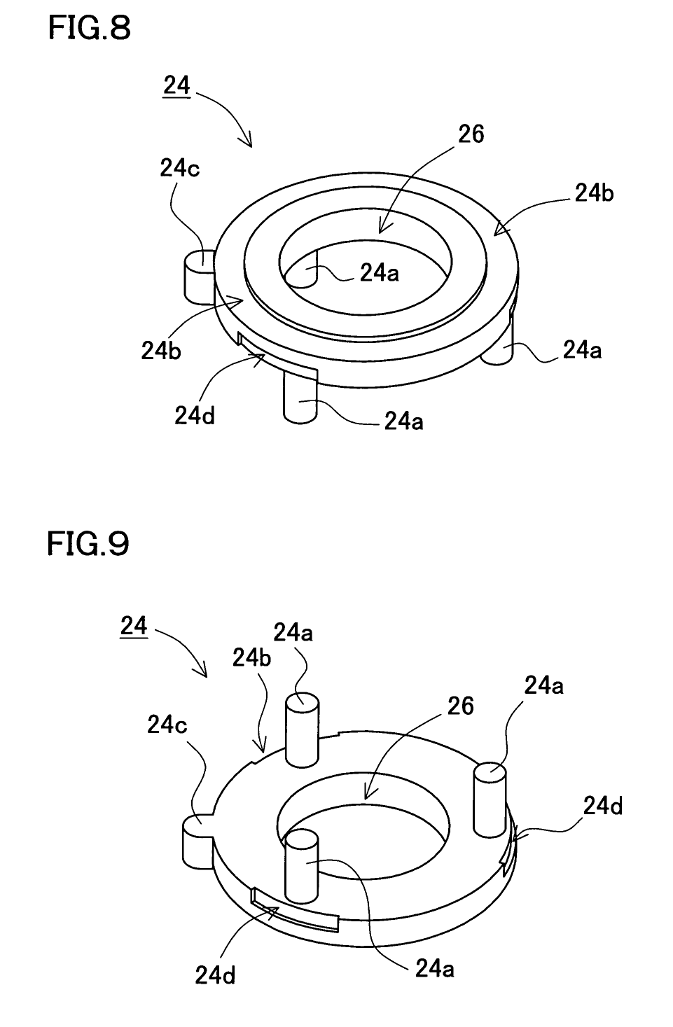

Two communication terminal slits 21C are formed at positions in the circuit board 21 that are faced to the penetrating opening 26 and are opposed to each other to accommodate the communication terminal 22, as shown in FIG. 6. Two soldering terminals 22A of the communication terminal 22 shown in FIG. 7 are inserted into the communication terminal slits 21C. The circuit board 21 is provided on its surface with electrical connection portions (not shown) that are connected to the soldering terminals 22A of the communication terminal 22 that are inserted into the slits. The soldering terminals 22A that are inserted into the communication terminal slits 21C are connected to the circuit board 21 by soldering. Also, the circuit board 21 is provided with positioning openings 21D. Support legs 24a of the first insulating formed part 24 shown in FIG. 8 and FIG. 9 are inserted into the positioning openings 21D. The positioning opening 21D has an inner diameter slightly greater than the outer diameter of the support leg 24a. The support legs 24a are inserted into the positioning openings 21D, and as a result the circuit board 21 and the first insulating formed part 24 are coupled in place.

As shown in FIG. 7, the communication terminal 22 that includes a pair of the soldering terminals 22A is formed by cutting a sheet metal into a circular, ring shape that has a predetermined width in plan view and includes the soldering terminals 22A that are arranged at positions in the ring shape that are opposed to each other. The soldering terminals 22A are bent downward. The ends of the soldering terminals 22A are inserted into the communication terminal slits 21C of the circuit board 21, and are connected to the circuit board 21 by soldering. The pair of soldering terminals 22A have the same height so that the communication terminal 22 is spaced away from the circuit board 21 and is secured in parallel to the circuit board 21. The interval between the circuit board 21 and the communication terminal 22 can be adjusted by the length of the soldering terminals 22A. In the case where the soldering terminal 22A is long, the interval between the communication terminal 22 and the circuit board 21 can be wide. In the case where the soldering terminal 22A is short, the interval between the communication terminal 22 and the circuit board 21 can be narrow. The ring-shaped communication terminal 22 has an inner diameter greater than the outer diameter of the protruding terminal 14 not to be in contact with the protruding terminal 14. Also, the outer diameter of the communication terminal 22 is smaller than the outer diameter of the base battery portion 10 so that the outer periphery of the communication terminal 22 is insulated by the second insulating formed part 25.

The first insulating formed part 24 and the second insulating formed part 25 are formed of an insulating material such as plastic by molding. The first insulating formed part 24 is arranged between the circuit board 21 and the communication terminal 22, and insulates the communication terminal 22 from the circuit board 21. The second insulating formed part 25 covers the outer periphery part of the board assembly portion 20.

FIGS. 8 and 9 are perspective views showing the first insulating formed part 24 as viewed from the top and bottom sides. The illustrated first insulating formed part 24 is formed of plastic by molding in a disk shape as a whole that is provided with a plurality of support legs 24a on its lower surface. The penetrating opening 26 is formed in the center of the first insulating formed part to accommodate the protruding terminal 14 of the base battery portion 10. The first insulating formed part has an outer diameter smaller than the outer diameter of the base battery portion 10. The inner diameter of the penetrating opening 26 is designed slightly greater than the outer diameter of the protruding terminal 14. Accordingly, the protruding terminal 14 can be inserted in the state where the clearance between the protruding terminal 14 and the penetrating opening 26 is small. Also, the first insulating formed part 24 has a stepped area 24b that is formed in a ring shape in plan view and is arranged on the outer peripheral rim of the upper surface of the first insulating formed part 24 to receive the communication terminal 22. The communication terminal 22 is fitted into the stepped area 24b, and is arranged at the predetermined position. The illustrated first insulating formed part 24 includes the three support legs 24a. When the board assembly portion 20 is secured to the base battery portion 10, the support legs 24a are guided into the ring-shaped groove 16 of the base battery portion 10 so that the board assembly portion 20 is coupled to the predetermined position of the base battery portion 10. For this reason, the support legs 24a have a length and are arranged at positions so that the board assembly portion 20 is arranged at the predetermined position of the base battery portion 10 in the state where the ends of the support legs 24a are in contact with the bottom of the ring-shaped groove 16 of the base battery portion 10. Also, the illustrated first insulating formed part 24 is provided on its outer periphery with positioning protrusion 24c so that the second insulating formed part 25 is coupled to the first insulating formed part 24 in place.

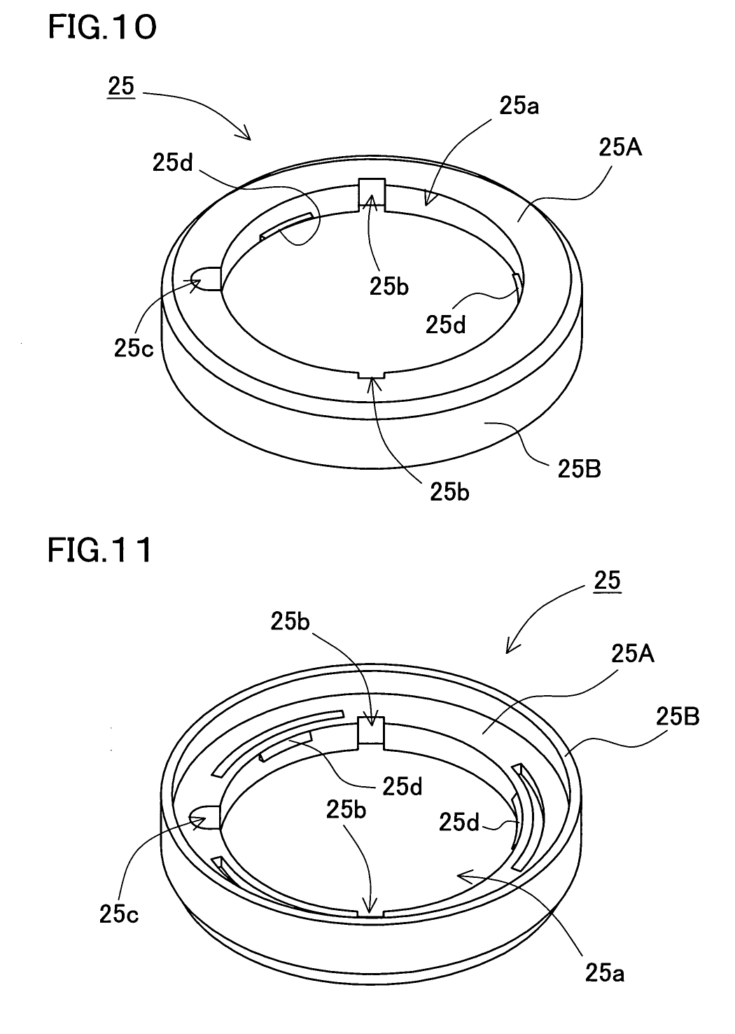

The second insulating formed part 25 is coupled to the first insulating formed part 24, and covers and insulates the outer periphery and the upper surface on the outer periphery side of the board assembly portion 20. FIGS. 10 and 11 are perspective views showing the second insulating formed part 25 as viewed from the top and bottom sides. The illustrated second insulating formed part 25 has a ring shape as a whole, and an L shape in section. The thus-shaped second insulating formed part 25 includes a peripheral wall 25B that covers the outer peripheral surface of the board assembly portion 20, and an end surface cover 25A that covers the upper-side surface of the board assembly portion 20. The peripheral wall 25B and the end surface cover 25A are coupled to form the L shape. The inner diameter of an opening 25a of the end surface cover 25A is substantially equal to the outer diameter of the communication terminal 22, more exactly, slightly greater than the outer diameter of the communication terminal 22. The communication terminal 22 is arranged in the opening 25a of the end surface cover 25A of the thus-shaped second insulating formed part 25 so that the surfaces of the end surface cover portion 25A and the communication terminal 22 are arranged coplanar with each other, as shown in the perspective view of FIG. 2 and the cross-sectional perspective view of FIG. 4. Also, the illustrated second insulating formed part 25 is provided on the inner periphery of the opening 25a with fit-in cut-outs 25b. The pair of soldering terminals 22A that are bent and arranged at the opposed positions of the communication terminal 22 are fitted into the fit-in cut-outs 25b in place. When the pair of solder terminals 22A that are provided to the communication terminal 22 are guided to and arranged in the fit-in cut-outs 25b in the opening 25a of the second insulating formed part 25, the communication terminal 22 is arranged at a predetermined position of the opening 25a.

Also, a positioning cut-out 25c is arranged in the inner periphery of the opening 25a of the second insulating formed part 25 shown in FIG. 10 and FIG. 11. The positioning protrusion 24c that is arranged on the outer periphery of the first insulating formed part 24 is fitted into the positioning cut-out 25c. When the positioning protrusion 24c that is provided to the first insulating formed part 24 is guided to and arranged in the positioning cut-out 25c in the opening 25a of the second insulating formed part 25, the first insulating formed part 24 is coupled to a predetermined position of the opening 25a. Also, three protruding interlock pawls 25d are formed integrally with the second insulating formed part 25 shown in FIG. 11 to be interlocked with the first insulating formed part 24. The illustrated second insulating formed part 25 is provided with the interlock pawls 25d that protrude inward from the inner surface of the opening 25a of the end surface cover 25A. The interlock pawls 25d are formed of plastic together with the second insulating formed part 25, as shown in FIG. 4. The interlock pawls 25d are elastically deformed, and are interlocked with the first insulating formed part 24. The first insulating formed part 24 is provided on its outer periphery with three interlock stepped areas 24d that can be interlocked with the three interlock pawls 25d.

As shown in the cross-sectional perspective view of FIG. 4, the end surface cover 25A of the second insulating formed part 25 covers the surface of the circuit board 21, the outer peripheral surface of the first insulating formed part 24 and the outer peripheral surface of the communication terminal 22 to insulate the surface of the circuit board 21 and the outer peripheral surface of the communication terminal 22. The peripheral wall 25B of the second insulating formed part 25 covers and insulates the outer periphery of the circuit board 21. In the cylindrical battery of FIG. 4, the first insulating formed part 24 and the communication terminal 22 have the same outer diameter so that the outer peripheral surfaces of the first insulating formed part 24 and the communication terminal 22 are arranged coplanar with each other. The outer peripheral surfaces of the first insulating formed part 24 and the communication terminal 22 that are arranged coplanar with each other are covered by the inner peripheral surface of the opening 25a of the end surface cover 25A of the second insulating formed part 25.

The aforementioned cylindrical battery is assembled by the following processes.

(1) The connection metal plate 17 is coupled to the sealing plate 13 of the base battery portion 10 by spot welding.

(2) Electronic components that compose the data-processing circuit are mounted on the circuit board 21.

(3) The negative terminal tab 27 is arranged in the notch 21B of the circuit board 21 and is connected to the circuit board 21 by soldering, spot welding or the like.

(4) The first insulating formed part 24 is arranged on the surface of the circuit board 21, and the circuit board 21 and the first insulating formed part 24 are coupled to each other. The support legs 24a of the first insulating formed part 24 are inserted into the positioning openings 21D so that the first insulating formed part 24 is coupled to the predetermined position of the circuit board 21.

(5) The communication terminal 22 is arranged in the stepped area 24b that is formed in the surface of the first insulating formed part 24, and the soldering terminals 22A of the communication terminal 22 are inserted into the communication terminal slits 21C that are formed in the circuit board 21. The ends of the soldering terminals 22A are coupled to the circuit board 21 by soldering. The communication terminal 22 is secured to the circuit board 21 by using the soldering terminals 22A. The soldering terminals 22A hold the first insulating formed part 24 so that the communication terminal 22 is secured to the circuit board 21.

(6) The circuit board 21 that is composed of the first insulating formed part 24 and the communication terminal 22 that are coupled to each other is coupled to the base battery portion 10, as shown in FIG. 2. In this case, the protruding terminal 14 of the base battery portion 10 is inserted into the penetrating openings 26 of the first insulating formed part 24 and the circuit board 21. The circuit board 21 is connected to the positive terminal of the battery through the connection tab 17A of the connection metal plate 17, and is connected to the negative terminal of the battery through the negative terminal tab 27. The connection tab 17A of the connection metal plate 17 is arranged in the notch 21A of the circuit board 21, and is connected to the circuit board 21 by soldering, spot welding or the like. The negative terminal tab 27 is connected to the caulked protruding section 15 of the exterior can 12 by spot welding.

(7) The second insulating formed part 25 is coupled to the first insulating formed part 24, as shown in FIG. 3. The interlock pawls 25d are caught in the interlock stepped areas 14d of the first insulating formed part 24 so that the second insulating formed part 25 is coupled to the first insulating formed part 24 as shown in FIG. 4.

(8) Finally, the outer peripheral surfaces of the board assembly portion 20 and the base battery portion 10 are covered by an insulating tube (not shown). The insulating tubing is a heat shrinkable tube, and covers and insulates the outer peripheral surface of the cylindrical battery to open on the both end surfaces of the cylindrical battery.

In the cylindrical battery according to the foregoing embodiment, the board assembly portion 20 includes the circuit board 21 that is provided with the data-processing circuit, and the communication terminal 22 that is connected to the data-processing circuit of this circuit board 21. However, in the cylindrical battery according to the present invention, the circuit that is mounted on the circuit board is not limited to the data-processing circuit. In the case where various types of electronic components are mounted on the board assembly portion, the cylindrical battery according to the present invention has a feature in that multifunction can be provided. In the cylindrical battery, a circuit that displays the remaining capacity of the base battery portion can be mounted in the board assembly portion, for example. In the board assembly portion, a remaining capacity detector circuit, an operation switch, and a display section that compose the remaining capacity display circuit are mounted on the circuit board. In the remaining capacity display circuit, in the state where the operation switch is ON, the remaining capacity detector circuit detects the remaining capacity of the base battery portion, and the display section can display the state of the battery based on the detected remaining capacity. The remaining capacity detector circuit detects the voltage of the base battery portion, and determines the remaining capacity of the base battery portion based on the detected voltage. A press switch can be used as the operation switch. An LED can be used as the display section. When the press switch is pressed, the remaining capacity display circuit can display the remaining capacity of the base battery portion. The remaining capacity of the base battery portion can be represented by the flashing state of the LED. The remaining capacity display circuit controls the flashing state of the LED in accordance with the remaining capacity of the base battery portion. For example, the LED stays OFF if the remaining capacity is in a range of 0 to 20%. The LED is flashed if the remaining capacity is in a range of 20 to 80%. The LED stays ON if the remaining capacity is in a range of 80 to 100%. Thus, the remaining capacity can be displayed. Also, the remaining capacity display circuit can change the color of LED or can change the LED in variety of flashing states in accordance with the levels of the remaining capacity of the base battery portion. Accordingly, in the cylindrical battery that includes the base battery portion remaining capacity display circuit that is mounted in the board assembly portion, since a user can easily check the remaining capacity of the battery, the cylindrical battery can be very conveniently used.

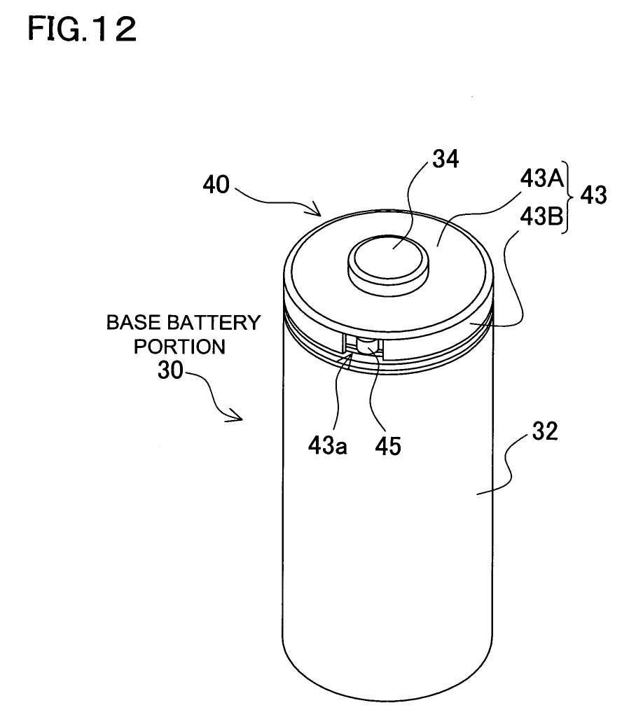

With reference to FIGS. 12 through 15, the following description describes a cylindrical battery that has the same exterior size as a standard size battery as a whole, and has a function that displays the remaining capacity of the battery. The illustrated cylindrical battery is a cylindrical AA size battery that has the same exterior size as an AA standard size battery. However, the exterior shape of a cylindrical battery according to the present invention is not limited to an AA standard size battery. The exterior shape of a cylindrical battery according to the present invention can be a circular cylindrical D, C or AAA size battery, or a prismatic PP3 size battery.

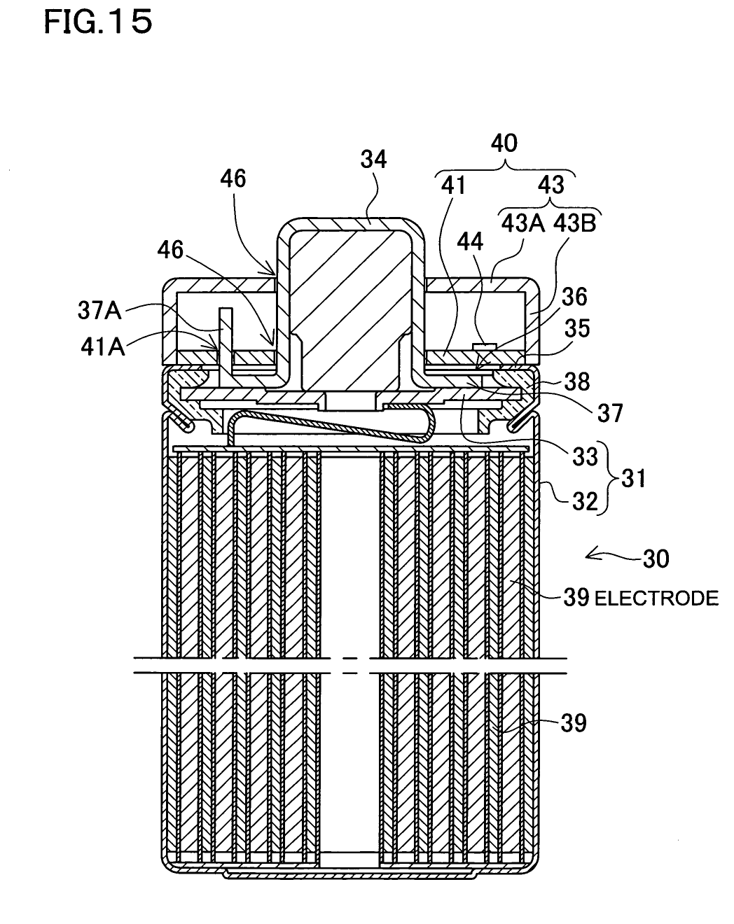

The cylindrical battery shown in FIGS. 12 through 15 includes a base battery portion 30, and a board assembly portion 40 that is secured on an end of the base battery portion 30 on a protruding terminal 34 side. As shown in FIG. 15, the base battery portion 30 includes an exterior case 31 that has a sealing structure that accommodates electrodes 39 and electrolysis solution. The exterior case 31 includes an exterior can 32 that is formed from a sheet metal into a circular cylindrical shape by presswork, and a sealing plate 33 that is formed of a sheet metal that closes the opening of the exterior can 32. The sealing plate 33 is fastened to the exterior can 32 by caulking the outer peripheral rim of the sealing plate 33 so that the opening of the exterior can 32 is sealed by the sealing plate 33. The sealing plate 33 is provided on the outer peripheral rim of the sealing plate 33 with a caulked protruding section 35 by caulking. The sealing plate 33 and the exterior can 32 are caulked to interpose an insulating member 38, and, in a well-known manner, the sealing plate 33 is connected to the electrode of the positive terminal, and the exterior can 32 is connected to the electrode of the negative terminal. The sealing plate 33 is provided with the protruding terminal 34 in the central part of the sealing plate 33. A ring-shaped groove 36 is formed between the protruding terminal 34 and the caulked protruding section 35.

In the cylindrical battery, in the state where the board assembly portion 40 is secured to the base battery portion 30 on the protruding terminal 34 side, the cylindrical battery has the same exterior size as a standard size battery. Accordingly, as compared with a typical standard size battery, which does not include the board assembly portion 40, the size of the base battery portion 30 is reduced corresponding to the size of the board assembly portion 40. Since the board assembly portion 40 is secured to the base battery portion 40 on the protruding terminal 34 side, the size of the base battery portion 30 is reduced corresponding to this part, that is, the length of the exterior can 32 is slightly shorter. Note that, in the cylindrical battery according to the present invention, since the protruding terminal 34 of the base battery portion 30 protrudes from the board assembly portion 40 to serve as the positive terminal of the output terminals, the dimension from the top end of the protruding terminal 34 to the bottom of the exterior can 32 is the same as the dimension of a general standard size battery, which does not include a board assembly portion. For this reason, the cylindrical battery according to the present invention, the height of the protruding terminal 34 of the base battery portion 30 that protrudes from the sealing plate 33 is configured higher than a general standard size battery. In the illustrated cylindrical battery, in the state where the board assembly portion 40 is secured to the base battery portion 30, the cylindrical battery has the same exterior size as an AA size battery. In other words, the board assembly portion 40 is configured in an exterior shape that gives the cylindrical battery the same exterior shape as a standard AA size battery in the state where the board assembly portion 40 is secured to the base battery portion 30.

As shown in FIGS. 12 through 15, the board assembly portion 40 includes a circuit board 41, and an insulating formed section 43. A data-processing circuit (not shown) that calculates the remaining capacity of the battery is mounted on the circuit board 41. The insulating formed section 43 insulates the circuit board 41 and positions the circuit board 41 in a predetermined position. The insulating formed section 43 is arranged above the circuit board 41, and is coupled to the base battery portion 30 on the protruding terminal 34 side to cover the whole circuit board 41.

In the illustrated cylindrical battery, in the state where the board assembly portion 40 is secured to the end of the base battery portion 30 on the protruding terminal 34 side, the protruding terminal 34 of the base battery portion 30 protrudes from the board assembly portion 40 to serve as an output terminal on the positive terminal side. For this reason, the board assembly portion 40 is provided on its central part with a penetrating opening 46 that receives the protruding terminal 34 of the base battery portion 30. When the protruding terminal 34 is inserted into the penetrating opening 46, the board assembly portion 40 is arranged at a predetermined position of the end of the base battery portion 30. The circuit board 41 has a ring shape. Accordingly, the board can have a large area. Also, since the circuit board 41 can be fitted into the protruding terminal 34 of the sealing plate 33, the board can be easily secured.

However, in the present invention, the shape of the board assembly portion is not limited to a ring shape that has a penetrating opening into which the protruding terminal of the base battery portion is inserted. Although not illustrated, the board assembly portion can have various types of shapes that allow the board assembly portion to be arranged on the end surface of the base battery portion on the protruding terminal side. In the cylindrical battery, for example, in the case where a circular cylindrical battery is used as the base battery portion, the shape of the board assembly portion can be a C shape or a sector shape that extends along the outer periphery of the cylindrical battery. Also, in the case where a prismatic battery is used as the base battery portion, the shape of the board assembly portion can be a rectangular parallelepiped shape that has an outer periphery that extends along the outer periphery of the prismatic battery. The board assembly portion does not necessarily extend along the whole periphery of the protruding terminal, but can be arranged to extend along a part of the periphery of the protruding terminal.

The cylindrical battery shown in FIGS. 12 through 15 detects the remaining capacity of the battery by means of the data-processing circuit that is mounted on the circuit board 41 of the board assembly portion 40. Although not illustrated, the data-processing circuit that calculates the remaining capacity of the battery includes a remaining capacity determining part that calculates the remaining capacity based on the voltage of the base battery portion 30. The data-processing circuit includes a voltage detector that detects the voltage of the base battery portion 30. The remaining capacity determining part determines the remaining capacity of the base battery portion 30 based on the detection voltage that is detected by the voltage detecting circuit. For example, the remaining capacity determining part calculates the remaining capacity based on comparison of the detection voltage with reference voltage that is stored in a storage component such as a memory.

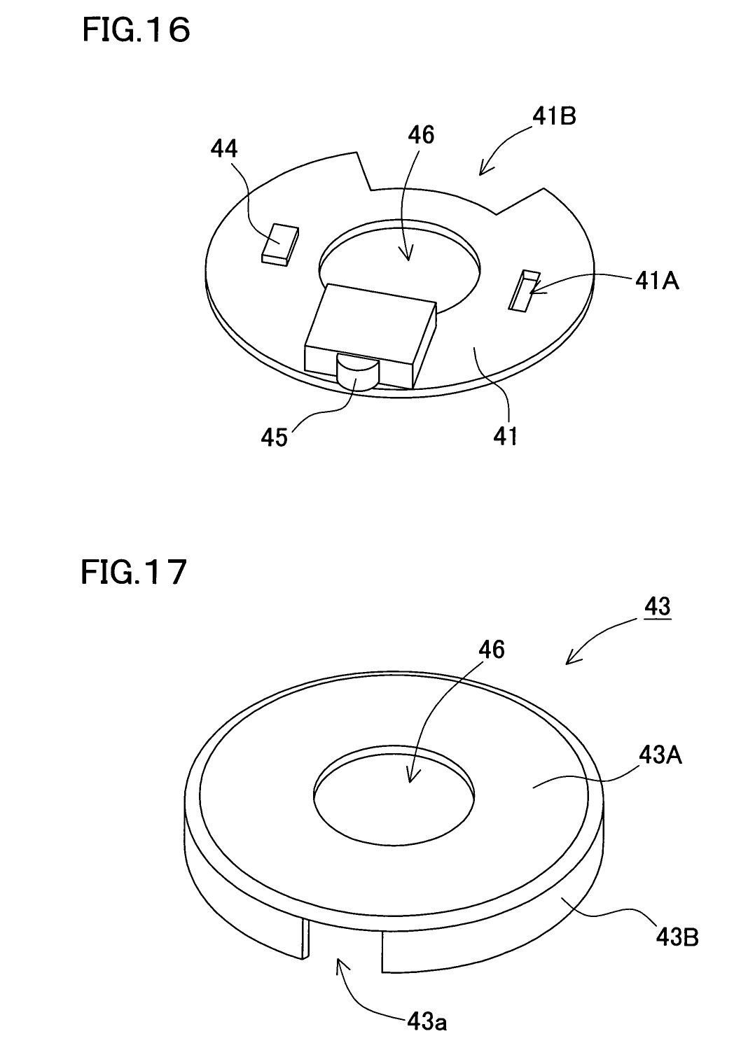

Also, the illustrated board assembly portion 40 includes a display section 44 that displays the remaining capacity of the battery that is determined by the data-processing circuit, and a switch 45 that causes the display section to display the remaining capacity. The display section 44 and the switch 45 shown in FIG. 16 are secured to the circuit board 41. Note that the display section and the switch may be secured to the insulating formed section.

The illustrated display section 44 is an LED. The whole of or a part of the insulating formed section 43 that is arranged above and covers the display section 44 as the LED is formed of transparent plastic so that light of the LED that is arranged inside the insulating formed section 43 passes outward through the insulating formed section 43. The insulating formed section 43 is not provided with an opening that exposes the display section 44 but allows light of the LED to pass through the insulating formed section 43 so that the light of the LED is visible the outside of the insulating formed section 43. However, the insulating formed section may be provided with an opening that exposes the display section so that the display section is exposed to display the remaining capacity of the battery outward.

The display section 44 as the LED changes the flashing state of the LED in accordance with the remaining capacity of the battery to display the remaining capacity. For example, the display section 44 changes the color of LED or the flashing pattern of the LED in accordance with the remaining capacity of the battery to display the remaining capacity. In the case where the display section changes the light emission color of the LED in accordance with the remaining capacity of the battery, the cylindrical battery has features in that the cylindrical battery aesthetically looks good, and the remaining capacity can be clearly displayed. In the case where the display section changes the flashing pattern of the LED in accordance with the remaining capacity of the battery, the display section can have a single color LED and can display the remaining capacity. For this reason, the cylindrical battery has features in that space can be saved, and the cylindrical battery can be configured at low cost. In the case where the display section has a single color LED, the display section can change the flashing cycle of the LED in accordance with the remaining capacity in a multi-step manner to display the different levels of the remaining capacity. The display section can display three types of the flashing patterns “OFF”, “FLASH” and “ON” in accordance with the remaining capacity of the base battery portion, for example. The memory of the data-processing circuit can store the flashing patterns of the LED. However the display section is not limited to an LED, the display can have any other structure that can display the remaining capacity of the battery outward. The display section can be a device that can changes the display form of the device in accordance with the remaining capacity of the battery (e.g., liquid crystal display).

The switch 45 is exposed from the insulating formed section 43 so that the user can press the switch 45. When the user presses the switch 45, the data-processing circuit determines and displays the remaining capacity of the base battery portion 30. In this case, the data-processing circuit determines the remaining capacity of the base battery portion 30 when the switch 45 is operated. Accordingly, the data-processing circuit is not continuously supplied with electric power from the base battery portion 30. Therefore, it is possible to effectively prevent a waste of electric power. In addition to this, in the case where the data-processing circuit is provided with a timer, the cylindrical battery can be configured to display the remaining capacity by means of the display section 44 only within a predetermined time period after detecting remaining capacity. In this configuration, it is possible to save the electric power of the base battery portion 30, and additionally to surely display the remaining capacity.

As stated above, the cylindrical battery that is provided with the data-processing circuit that detects the remaining capacity has features in that the remaining capacity can be easily checked without using an additional device in the case where the cylindrical battery is used or is left after charged, and the remaining capacity can be simply configured and manufactured.

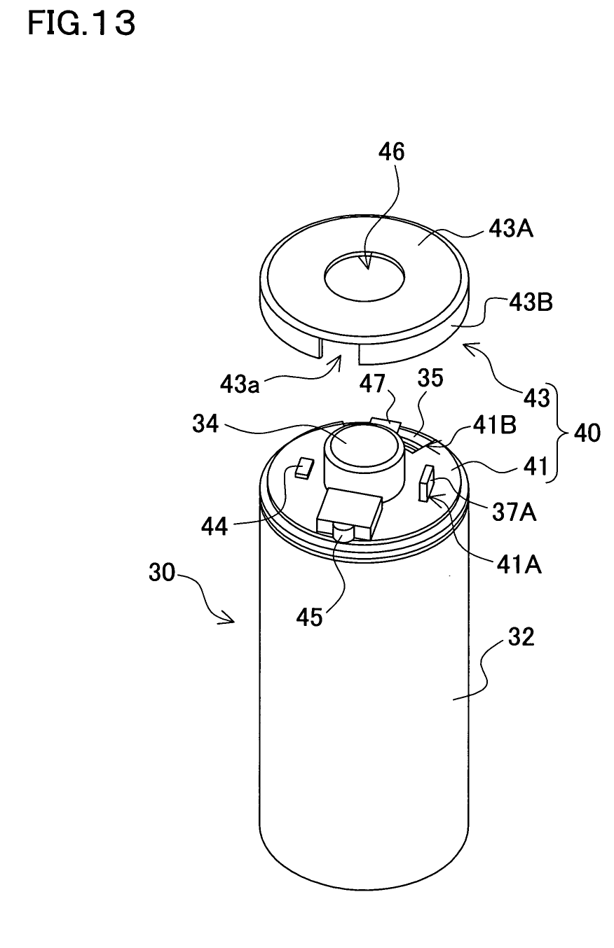

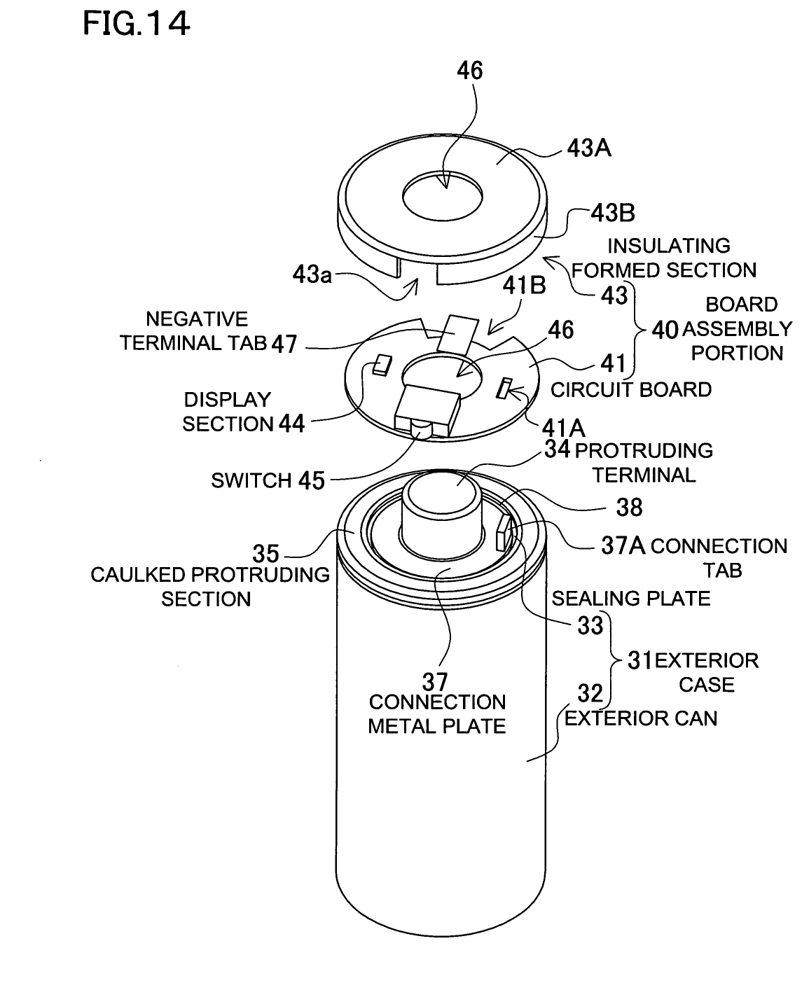

The aforementioned data-processing circuit of the circuit board 41 is operated by electric power that is supplied from the base battery portion 30. Accordingly, the circuit board 41 is connected to the positive and negative terminals of the base battery portion 30. The circuit board 41 shown in FIGS. 13 and 14 is provided with a penetrating opening 41A and a notch 41B. The circuit board 41 is connected to the positive and negative terminals of the base battery portion 30 through the penetrating opening 41A and the notch 41B to be supplied with electric power from the base battery portion 30. Note that the circuit board may be provided with two notches that reach the outer periphery of the circuit board so that one of the notches is used for connection to the positive terminal and another is used for connection to the negative terminal.

The illustrated circuit board 41 is connected to the positive terminal of the base battery portion 30 through the protruding terminal 34. As shown in FIGS. 14 and 15, the protruding terminal 34 is formed of a sheet metal by presswork into a shape that has a protruding part in the central part of a circular flat plane part of the sheet metal. A connection metal plate 37 that is the circular flat plane part of the sheet metal is secured to the upper surface of the sealing plate 33, and is connected to the positive terminal of the base battery portion 30. The connection metal plate 37 of the protruding terminal 34 is secured to the sealing plate 33 by spot welding. The connection metal plate 37 has a ring shape, and is provided with a connection tab 37A that protrudes from the outer periphery part of the connection metal plate 37 to be connected to the circuit board 41. The connection tab 37A of the connection metal plate 37 is bent upward, and is inserted into the penetrating opening 41A of the circuit board 41. The connection tab 37A is connected to the circuit board 41 by soldering, spot welding, wire-bonding or the like. Note that, the connection metal plate 37 may have other shape than a ring shape that can transmit electric power from the sealing plate 33 at low electrical power loss.

Also, the circuit board 41 is connected to the negative terminal of the base battery portion 30 through the negative terminal tab 47, as shown in FIGS. 13 and 14. The negative terminal tab 47 of the circuit board 41 is secured and is connected to the exterior can 32 as the negative terminal of the base battery portion 30. The negative terminal tab 47 is a sheet metal, and is arranged in the notch 41B of the circuit board 41. The negative terminal tab 47 is connected to the circuit board 41 by soldering, spot welding, wire-bonding or the like. The negative terminal tab 47 that is arranged in the notch 41B is secured to the caulked protruding section 35 of the exterior can 32 by spot welding or the like.

The insulating formed section 23 is formed of an insulating material such as plastic by molding. The LED that is the display section 44 is arranged inside the insulating formed section 43. The whole of or a part of the insulating formed section 43 is formed of transparent plastic so that light of the LED passes outward through the insulating formed section 43. However, in the case where the insulating formed section is provided with an opening that exposes the display section, the insulating formed section can be formed of a non-transparent plastic material.

As shown in FIGS. 12 through 15, the insulating formed section 23 is arranged to cover the upper part of the circuit board 41 so that the protruding terminal 34 protrudes from the central part of the insulating formed section 23. As shown in FIG. 17, the second insulating formed section 23 has a ring shape as a whole, and an L shape in section. The thus-shaped insulating formed section 23 includes a peripheral wall 43B that covers the outer peripheral surface of the circuit board 41, and an end surface cover 43A that covers the upper-side surface of the circuit board 41. The peripheral wall 43B and the end surface cover 43A are coupled to form the L shape.

In order that the peripheral wall 43B can accommodate the circuit board 41 inside the lower end area of the peripheral wall 43B, the inner diameter of the peripheral wall 43B is designed substantially equal to or slightly greater than the outer diameter of the circuit board. Also, The outer diameter of the peripheral wall 43B is designed substantially equal to the outer diameter of the base battery portion 30 so that the cylindrical battery has an appearance that similar to a standard size battery as a whole. Also, the illustrated peripheral wall 43B is provided with an opening 43a that opens to outwardly expose the switch 45 that is secured to the circuit board 41. Accordingly, when the user presses the protruding part of the switch 45 through the opening 43a, the switch 45 can be activated.

The end surface cover 43A is provided on its central part with the penetrating opening 46 that receives the protruding terminal 34 of the base battery portion 30. The inner diameter of the penetrating opening 46 is designed slightly greater than the outer diameter of the protruding terminal 34. Accordingly, the protruding terminal 34 can be inserted in the state where the clearance between the protruding terminal 34 and the penetrating opening 46 is small.

The aforementioned insulating formed section 43 is at arranged the end of the base battery portion 30 on the protruding terminal 34 side. As shown in FIG. 12 and FIG. 15, the peripheral wall 43B covers and insulates the outer periphery of the circuit board 41, and the end surface cover 43A covers and insulates the surface of the circuit board 41. The protruding terminal 34 is inserted into the penetrating opening 46 of the insulating formed section 43. The lower end surface of the peripheral wall 43B contacts the caulked protruding section 35 of the base battery portion 30. The insulating formed section 43 is arranged at a predetermined position so that the switch 45 is exposed from the opening 43a. In the state where the insulating formed section 43 is arranged at the predetermined position on the end of the base battery portion 30, the protruding terminal 34 protrudes from the end surface cover portion 43A so that the end of the protruding terminal 34 protrudes upward from the upper surface of the board assembly portion 40.

The aforementioned cylindrical battery is assembled by the following processes.

(1) The protruding terminal 34 is secured to the sealing plate 33 of the base battery portion 30. The connection metal plate 37 of the protruding terminal 34 is secured to the sealing plate 33 by spot welding.

(2) Electronic components that compose the data-processing circuit for remaining capacity determination are mounted on the circuit board 41.

(3) The negative terminal tab 47 is arranged in the notch 41B of the circuit board 41 and is connected to the circuit board 41 by soldering, spot welding or the like.

(4) The circuit board 41 is coupled to the base battery portion 30, as shown in FIG. 14. In this process, the protruding terminal 34 of the base battery portion 30 is inserted into the penetrating opening 46 of the circuit board 41, and the connection tab 37A of the connection metal plate 37 is inserted into the penetrating opening 41A.

(5) The circuit board 41 that is arranged at the predetermined position of the base battery portion 30 is coupled to the base battery portion 30, as shown in FIG. 13. The circuit board 41 is connected to the positive terminal of the battery through the connection tab 37A of the connection metal plate 37, and is connected to the negative terminal of the battery through the negative terminal tab 47. The connection tab 37A of the connection metal plate 37 is inserted into the penetrating opening 41A of the circuit board 41, and is connected to the circuit board 41 by soldering, spot welding or the like. The negative terminal tab 47 is connected to the caulked protruding section 35 of the exterior can 32 by spot welding.

(6) The insulating formed section 43 is coupled to the end of the base battery portion 30, as shown in FIG. 12. The protruding terminal 34 is inserted into the penetrating opening 46 of the insulating formed section 43. In the state where the lower end surface of the peripheral wall 43B contacts the caulked protruding section 35 of the base battery portion 30, the insulating formed section 43 is coupled to the outer peripheral surface of the circuit board 41. The insulating formed section 43 is secured to the circuit board 41 by an adhesive, ultrasonic welding, or an interlock structure. The insulating formed section 43 is arranged at the predetermined position so that the switch 45 is exposed from the opening 43a, and is coupled so that the end of the protruding terminal 34 protrudes upward from the upper surface of the board assembly portion 40.

(7) Finally, the outer peripheral surfaces of the board assembly portion 40 and the base battery portion 30 are covered by an insulating tube (not shown). The insulating tubing is a heat shrinkable tube, and covers and insulates the outer peripheral surface of the cylindrical battery to open on the both end surfaces of the cylindrical battery.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2006-356923 filed in Japan on Dec. 29, 2006, and No. 2007-239120 filed in Japan on Sep. 14, 2007, the contents of which are incorporated herein by reference.

What is claimed is:

1. A cylindrical battery comprising:
a base battery portion that includes an exterior case that includes a cylindrical exterior can as the negative terminal of the base battery portion and a sealing plate that closes and seals an opening of the exterior can by caulking, and has a sealing structure that accommodates electrodes and electrolysis solution, the sealing plate being provided with a protruding terminal as the positive terminal of the base battery portion in the central part of the sealing plate and being provided with a caulked protruding section by caulking on the outer peripheral rim of the sealing plate; and
a board assembly portion that is secured on an end of the base battery portion on the protruding terminal side, wherein
the board assembly portion includes a circuit board that is provided with a data-processing circuit, a communication terminal that is connected to the data-processing circuit on the circuit board, and an insulating formed section that insulates the circuit board and positions the communication terminal at a predetermined position, wherein
a penetrating opening is formed in the central part of the board assembly portion to receive the protruding terminal of the base battery portion, and the communication terminal that is formed in a ring shape is secured around the periphery of the penetrating opening on the upper surface side of the board assembly portion, wherein
a connection metal plate is secured on the surface of the sealing plate, and includes a connection tab that is connected to the circuit board, wherein
the protruding terminal of the base battery portion is inserted into the penetrating opening of the board assembly portion so that the board assembly portion is secured on the end of the base battery portion on the protruding terminal side, and the connection tab of the connection metal plate is connected to the circuit board so that the circuit board is connected to the protruding terminal, wherein
the protruding terminal of the base battery portion has a height that protrudes from the upper surface of the board assembly portion that is secured to the base battery portion, wherein
the whole cylindrical battery has the same exterior size as a standard size battery in the state where the board assembly portion is secured to the base battery portion.

2. The cylindrical battery according to claim 1, wherein the whole cylindrical battery has the same exterior size as an AA size battery.

3. The cylindrical battery according to claim 1, wherein the data-processing circuit that is provided on the circuit board is connected to the positive and negative terminals of the base battery portion to be supplied with electric power from the base battery portion.

4. The cylindrical battery according to claim 1, wherein the insulating formed section includes a first insulating formed part that is arranged between the circuit board and the communication terminal, and a second insulating formed part that is coupled to the first insulating formed part and covers the outer peripheries of the circuit board and the communication terminal.

5. The cylindrical battery according to claim 1, wherein the first insulating formed part has a ring-shaped stepped area that can receive the communication terminal, and the communication terminal is fitted in the stepped area.

6. The cylindrical battery according to claim 1, wherein a ring-shaped groove is arranged between the protruding terminal and the caulked protruding section, wherein the first insulating formed part includes support legs that are inserted into positioning openings that are formed in the circuit board so that, when the support legs pass through the circuit board and are arranged in the ring-shaped groove, the first insulating formed part is secured at a predetermined position of the base battery portion.

7. The cylindrical battery according to claim 1, wherein the circuit board has notches on the outer peripheral rim of the circuit board, and is connected to the positive and negative terminals of the base battery portion in the notches.

8. The cylindrical battery according to claim 7, wherein the connection metal plate that is provided on its outer periphery with the connection tab that is connected to the circuit board is secured on the surface of the sealing plate, wherein the connection tab of the connection metal plate is connected to the circuit board in the notch of the circuit board so that the circuit board is connected to the protruding terminal.

9. The cylindrical battery according to claim 1, wherein the data-processing circuit that is provided on the circuit board calculates one type of or a plurality types of information on the remaining capacity of the battery, the deterioration degree of the battery, and the memory effect of the battery, and provides the one type of or the plurality types of information through the communication terminal.

10. A cylindrical battery comprising:
a base battery portion that includes an exterior case that includes a cylindrical exterior can as the negative terminal of the base battery portion and a sealing plate that closes and seals an opening of the exterior can by caulking, and has a sealing structure that accommodates electrodes and electrolysis solution, the sealing plate being provided with a protruding terminal as the positive terminal of the base battery portion in the central part of the sealing plate; and
a board assembly portion that is secured on an end of the base battery portion on the protruding terminal side, wherein
the board assembly portion includes a circuit board that is provided with an electronic element, and an insulating formed section that insulates the circuit board, wherein
a connection metal plate is secured on the surface of the sealing plate, and includes a connection tab that is connected to the circuit board, wherein
the board assembly portion is secured on the end of the base battery portion on the protruding terminal side, and the connection tab of the connection metal plate is connected to the circuit board so that the circuit board is connected to the protruding terminal, wherein
the protruding terminal of the base battery portion has a height that protrudes from the upper surface of the board assembly portion that is secured to the base battery portion, wherein
the whole cylindrical battery has the same exterior size as a standard size battery.

11. The cylindrical battery according to claim 10, wherein the exterior case is provided with a caulked protruding section on the outer peripheral rim of the sealing plate by the caulking, and a negative terminal tab that is connected to the circuit board is connected to the caulked protruding section.

12. The cylindrical battery according to claim 10, wherein the circuit board of the board assembly portion is provided with a data-processing circuit that calculates a battery remaining capacity.

13. The cylindrical battery according to claim 10, wherein a data-processing circuit that is provided on the circuit board to calculate a battery remaining capacity is operated by electric power that is supplied from the base battery portion, wherein the data-processing circuit calculates the battery remaining capacity of the base battery portion that is used as a power supply that operates the data-processing circuit.

14. The cylindrical battery according to claim 10, wherein the board assembly portion includes a display section that displays a battery remaining capacity, and a switch that causes the display section to display the battery remaining capacity.
